(19) United States
(12) Patent Application Publication
(10) Pub. No.: US 2009/0308362 A1
(43) Pub. Date: Dec. 17, 2009

(54) FUEL HEATER

(75) Inventors: Jens Schneider, Leonberg (DE); Jean-Marc Couffignal, Auzits (FR); Simon Schmittinger, Renningen (DE); Andreas Reissner, Stuttgart (DE); Vera Wein, Stuttgart (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/304,299

(22) PCT Filed: Sep. 12, 2007
(86) PCT No.: PCT/EP2007/059564

§ 371 Date: Aug. 18, 2009

(30) Foreign Application Priority Data
Nov. 8, 2006 (DE) 10 2006 052 634.1

(51) Int. Cl. F02G 5/00

(52) U.S. Cl. 123/557

(57) ABSTRACT

An apparatus for heating fuel, in particular alcohol, for the operation of combustion engines. The latter can be operated with alcohol or with an alcohol/gasoline mixture. The apparatus for heating fuel is integrated into the injection system of the combustion engine operable with alcohol or with an alcohol/gasoline mixture. The apparatus comprises a thin-walled heating tube that is received in a housing and surrounds a heating element. The heating element is produced from a material that exhibits a considerable rise in its electrical resistance with increasing temperature.

### FIELD OF THE INVENTION

The present invention relates to an apparatus for heating fuel.

### BACKGROUND INFORMATION

In some countries, alcohol is used to operate internal combustion engines. It is less expensive there to operate an internal combustion engine with alcohol than with gasoline or diesel fuel. If, for example, spark-ignition engines are operated with alcohol, they can be started only at a temperature above 14° C. This circumstance is taken into account at present by the fact that the motor vehicle contains a second tank, including conduits, that contains ordinary gasoline. At temperatures below 14° C., the spark-ignition engine is started with gasoline. After a few minutes, when the internal combustion engine has reached a specific temperature, operation can then be switched over to alcohol.

The fact that this approach requires the provision of two tanks in a motor vehicle is disadvantageous. These tanks necessitate more room in the vehicle, and the vehicle is also more costly as a result. In the summer months, when the ambient temperature is always above 14° C., gasoline is no longer required to start the spark-ignition engine. If the tank is not emptied at the beginning of the warm season, residual gasoline remaining in the fuel tank can become too viscous in the conduits and the tank, since the more-volatile constituents evaporate. When it becomes colder, on the other hand, starting with gasoline is no longer possible in such a case because the conduits and tanks are clogged. The conduits and the tank for storing the gasoline must in this case be cleaned or even replaced.

German patent document DE 20 2005 016 047 U1 discusses a device for preheating biofuels for diesel engines. This device has a tubular piece and a hollow element between which an annular gap is present. The latter is on the one hand made sufficiently large to enable the passage of the requisite quantity of fuel, but on the other hand is designed to be sufficiently small that only the smallest possible volume of fuel is stored between the tubular piece and hollow element.

German patent document DE 102 48 802 A1 refers to a sheathed-element glow plug having a greatly shortened control coil. According to this approach, a sheathed-element glow plug is proposed for a combustion engine, said plug encompassing a plug housing; a connector apparatus, attached to the plug housing, for the glow-plug current; and a glow tube coupled to the connector apparatus. Said tube is sealed on its side facing away from the plug housing. Also disposed in the glow tube is a wire-coil-shaped resistance element provided on a connector stud coupled to the connector apparatus, the resistance element being made up of a heating coil and a control coil. The control coil has a resistance between 20 and 100 mΩ. According to this approach, the entire resistance element provided in the glow tube, occupying one-third to two-thirds of the open length of the glow tube, is concentrated in the region of the glow-tube end facing away from the plug housing.

German patent document DE 197 55 822 A1 refers to a sheathed-element glow plug. The sheathed-element glow plug has a modified insertion/pressure connection, so that both radial and axial delivery of the centering windings of the glow coil into a corresponding U-shaped surround of a connector stud is possible. After prepositioning of the glow coil in the surround, radial pressing of the glow coil and connector stud can be performed; or, if the geometry is correspondingly configured, the surround can be entirely eliminated. The opening at the periphery of the connector stud in the region of the surround enables both radial and axial accessibility of the internal contour of the surround. Complete cleaning of organic lubricants, as well as reliable cleaning inspection, can thereby be guaranteed. The rate of premature failures of sheathed-element glow plugs caused by organic contamination is thereby decreased.

### SUMMARY OF THE INVENTION

According to the exemplary embodiments and/or exemplary methods of the present invention, a heat source is proposed that is integrated into the injection system and that serves for preheating of the fuel. The heat source proposed according to the present invention, which may be embodied as a fuel heater integrated into the injection system, encompasses a closed, tubularly configured metal heating tube into which a heating element made of metal is installed. The construction of the fuel heater proposed according to the present invention and integrated into the injection system corresponds to that of the metal sheathed-element glow plugs outlined above with reference to the existing art.

A helical heating wire is intermaterially connected, e.g. welded, to the heating tube on a side facing away from the housing. On the other side, the helically configured heating wire is connected in electrically conductive fashion to a connector stud at whose end the electrical connector is located. A ceramic powder, which is usually magnesium oxide, serves as electrical insulation with respect to the heating tube between the turns of the helically configured heating wire.

Economical and corrosion-resistant heating tubes, which are manufactured from non-corroding special steel (Inox) or copper-based alloys, are used for the heat sources proposed according to the present invention. Corrosion-resistant heating tubes manufactured from copper-based alloys have the additional advantage of very good thermal conductivity; in addition, Ni—Cr alloys, for example Inconel 2.4851 or 2.4633 or the like, can be used as materials.

An optimization of heat dissipation from the heating tube of the heat source proposed according to the present invention is accomplished by embodying it with a thin wall thickness that is typically a few tenths to several tenths of a millimeter, or by increasing the texturing of the surface by fluting, diamond-patterning, or a texture similar to a golf ball, and by application of a filling. For filling of the heating tube, finely particulate MgO may be used as an insulation and thermal-conduction powder.

Since it may be expected that a combustion engine operated with alcohol will also be operated with gasoline alone and with an alcohol/gasoline mixture, consideration must be given to the flash point of gasoline, which is approximately 300° C. A fast-responding overheating protection device is therefore of importance; said device reliably prevents the surface of the heat source proposed according to the present invention from reaching the ignition temperature of the fuel mixture, and (?ensures) that the maximum temperature at the surface of the heater is at most 250° C.

What is used as a heating element in the fuel heater proposed according to the present invention and integrated into the injection system is a helical metal wire that has a specific electrical resistance from 0.07 μΩm to 0.6 μΩm at 20° C., The increase in resistance with increasing temperature should be as large as possible. This embodiment does not enable self-regulation, but the resistance also rises when the temperature of the heating element rises. This is detected by way of a control unit, so that the heating element can be switched off. The advantage associated therewith is that the resistance of the heating element rises even if only a small portion of the heating element overheats. This can very easily be brought about by the formation of gas bubbles (air, fuel vapor) in the fuel. An approach using a conventionally installed temperature sensor would discover this local overheating only if the location having the temperature sensor were located inside the gas bubble. This risk is eliminated by the use of a heating element whose resistance increase with rising temperature is a large as possible, i.e. such that the heating element exhibits a sharp rise in its electrical resistance as the temperature increases.

The invention is described below in further detail with reference to the drawings.

### BRIEF DESCRIPTION OF THE DRAWINGS

The FIGURE presents a longitudinal section through the fuel heater proposed according to the present invention and integrated into the injection system.

### DETAILED DESCRIPTION

The drawing presents an exemplifying embodiment of the fuel heater proposed according to the present invention and may be integrated into the injection system of a combustion engine. The fuel heater encompasses a round plug 1 that represents the positive terminal of the fuel heater integrated into the injection system of the combustion engine. Round plug 1 is insulated via an insulating washer 2 with respect to a housing 4 of the fuel heater integrated into the injection system. A housing seal 3, which seals housing 4 against external environmental influences such as water, dirt, or other fluids, can be introduced between insulating washer 2 and housing 4.

A connector stud 6 extends through housing 4 and is electrically and mechanically contacted to round plug 1. Alternatively, a screw contact can also be used, instead of a round plug, to make electrical contact to connector stud 6. A heating element seal 5 is located between connector stud 6 and heating tube 7. Connector stud 6 furthermore extends through a heating tube 7 that is received in the bore of housing 4. Heating tube 7 has a wall thickness 11 of only a few tenths of a mm to several tenths of a mm, typically at least 0.25 mm, so that the thermal conductivity of heating tube 7 is maximized. Optimization of the heat transfer or thermal conductivity can be brought about on the one hand by thin wall thicknesses 11, or on the other hand by increasing the texturing of the surface of heating tube 7, for example by fluting it, applying a diamond-like or golf-ball-like pattern on the external peripheral surface thereof, or also by way of a filling of finely particular MgO, which serves as an insulating and thermal-conduction powder.

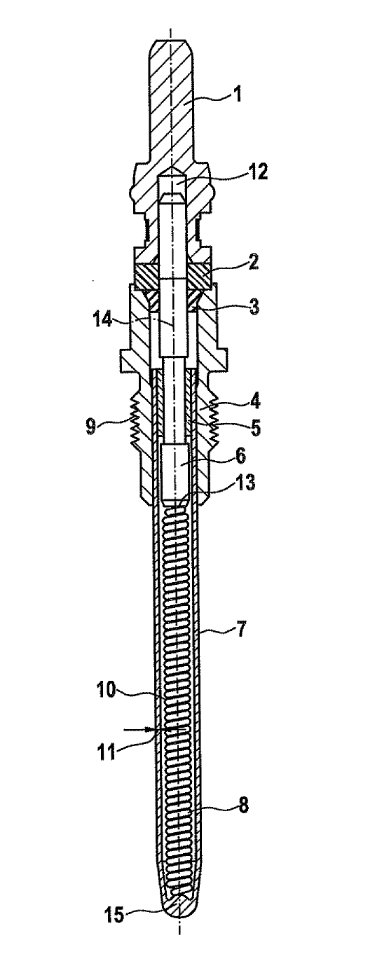

Connector stud 6, surrounded by the thin-walled heating tube 7, makes contact at one end face 13 with the helically configured heating element 8, which extends from end face 13 of connector stud 6 to tip 15 of the fuel heater according to FIG. 1 integrated into the injection system. Cavity 10, resulting from the underdimensioning in terms of the diameter of connector stud 6 as compared with the inside diameter of the thin-walled heating tube 7, is filled with a ceramic powder such as, for example, magnesium oxide, which serves as an insulator between connector stud 6 and heating tube 7.

Heating tube 7 of the fuel heater proposed according to the present invention and may be integrated into the injection system is manufactured from an economical and corrosion-resistant material such as, for example, non-corroding special steel (Inox), or from copper-based alloys. Copper-based alloys for the manufacture of heating tube 7 additionally have the advantage of very good thermal conductivity. Optimization of heat transfer is achieved by embodying heating tube 7 with a very thin wall thickness 11 that is typically at least 0.25 mm, or by enlarging the heat-dissipating surface area by texturing it, e.g. by fluting, diamond-patterning, or a texture similar to a golf ball's surface. Heat transfer out of the thin-walled heating tube 7 proposed according to the present invention can furthermore be improved by a filling of finely particulate magnesium oxide as an insulating and thermal-conduction powder. Optimization of heat transfer from the fuel heater proposed according to the present invention and may be integrated into the injection system of the combustion engine is important because the fuel heater produces a heat output from 150 W to 250 W.

In order to account for the fact that a combustion engine operated with alcohol is also operated with gasoline alone, which has a flash point of 300° C., the fuel heater proposed according to the present invention and may be integrated into the injection system is equipped with an overheating protection device. The overheating protector ensures that the surface of the fuel heater proposed according to the present invention, in particular the surface of heating tube 7, does not rise to the ignition temperature of the fuel mixture, and ensures that the maximum temperature of the external peripheral surface of heating tube 7 does not exceed approximately 250° C. Overheating protection is guaranteed by the fact that the helically configured, coil-shaped heating element 8 may be embodied as a metal wire that has a specific electrical resistance from 0.07 μΩm to 0.6 μΩm at 20° C. The metallic material from which the helically configured heating element 8 may be produced to exhibit a large increase in resistance with rising temperature. This embodiment does not enable self-regulation, but the overheating protection device ensures that as the fuel heater increasingly heats up, the resistance of heating element 8 also rises, and that the resistance value is compared with a threshold value. This is implemented by way of a control unit that, when the threshold value is reached, switches off the current flow to heating element 8 via the positive terminal of connector stud 6. The first and/or second derivative of the current over time can also be used to detect overheating. After an initial transient, an equilibrium state is established for the measured current during normal operation. If, after the initial transient, the current sensed by the control unit and differentiated deviates from the differentiated value, i.e. if the derivative over time is not equal to zero, the current flow to heating element 8 is switched off. Overheating can thereby be detected without the influence of production tolerances.

The advantage of this variant is that a rise in the resistance of the fuel heater can be detected even if only a small part of the fuel heater overheats. This can very easily be brought about by gas bubbles in the fuel that are formed by air bubbles or fuel vapor. If a temperature sensor were integrated into the fuel heater, it would be able to discern a rise in temperature only if the installation point of the temperature sensor were located in a gas bubble. The embodiment of the fuel heater proposed according to the present invention ensures that overheating even of only a small portion of the fuel heater can be detected by recognizing a rise in resistance, and can be reacted to with a shutdown.

As is evident from the drawing, connector stud 6 extends in housing 4 of the fuel heater may have as far as the lower end of housing 4. Connector stud 6 can also be made shorter or longer, coordinated with the length of the coil-shaped heating element 8. Heating tube 7 is also recessed into housing 4, and is secured to the aforementioned connector stud 6 in the interior of housing 4 with interposition of a heating element seal 6. End face 13 of connector stud 6 contacts the coil-shaped heating element 8, which extends from end face 13 to tip 15 of the fuel heater through the greater part of heating tube 7, which is embodied with a thin wall thickness 11. A cavity 10 inside heating tube 7 between its inner side and the coil-shaped heating element 8 may be filled with an insulating material such as, for example, magnesium oxide. The function of the insulating material (which may be magnesium oxide) received in cavity 10 is on the one hand to insulate the individual turns of the preferably coil-shaped heating element 8 with respect to one another, and to insulate the coil-shaped heating element 8 with respect to the tube wall of heating tube 7. The insulating material received in cavity 10 furthermore improves heat transport from the coil-shaped heating element 8 to heating tube 7.

Lastly, the insulating material stored in cavity 10 serves for mechanical immobilization of the preferably coil-shaped heating element 8 that extends substantially over the axial length of heating tube 7. The disposition inside heating tube 7, as evident from the drawing, of a heating element 8 embodied in one piece and configured in a coil shape, enables transfer of a high level of heat output through the wall of heating tube 7. Because the outer side of heating tube 7 always has fuel flowing around it, i.e. is immersed in said fuel, the heat that is produced is also carried off by the surrounding fluid. Whereas with sheathed-element glow plugs known from the existing art it is their tip 15 that is heated first, the fuel heater proposed according to the present invention produces uniform heating of the entire external peripheral surface of heating tube 7 below housing 4. The largest possible heat transfer surface area is thus created, so that the fuel stored in the injection system, e.g. alcohol, can be heated quickly. The fuel heater proposed according to the present invention does not require cooling, since the medium that surrounds it, i.e. fuel, receives the heat generated by the fuel heater and discharges it from the fuel heater.

With the fuel heater proposed according to the present invention, the heating element 8 used is, in particular, one that is configured as a helically configured metal wire that has a specific electrical resistance from 0.07 μΩm to 0.6 μΩm at a temperature of 20° C. A metallic material that exhibits the PTC effect, i.e. that exhibits a distinct rise in resistance with increasing temperature may be used. When the fuel heater proposed according to the present invention becomes hotter, its resistance also rises, which in turn can be recognized by a control unit that, in such a case, switches off the fuel heater proposed according to the present invention.

The advantage of using a material that exhibits a very sharp rise in resistance with increasing temperature is that it is also possible to recognize when only a small portion of the heater is overheating, since in such a case the resistance of the fuel heater proposed according to the present invention likewise rises. Overheating of only a small portion of the fuel heater proposed according to the present invention can be caused by the fact that a gas bubble is located at the outer periphery of heating tube 7, which bubble would in this case result in a local temperature elevation in the enveloping surface of heating tube 7 surrounding heating element 8.

Selection of the metallic material from which the coil-shaped, helically configured heating element 8 may be produced, and which exhibits a strong PTC effect, allows a temperature elevation of this kind to be recorded immediately even if it occurs only locally at the periphery of the fuel heater, and allows the control unit of the fuel heater proposed according to the present invention to perform a shutoff of the fuel heater.

1-11. (canceled)

12. An apparatus for heating fuel, which includes alcohol, for operating a combustion engine that is operated with one of alcohol and an alcohol/gasoline mixture, the apparatus comprising:
a heating element; and
a housing and a thin-walled heating tube that surrounds the heating element;
wherein the heating material is made of a material that exhibits a rise in its electrical resistance with an increasing temperature.

13. The apparatus of claim 12, wherein the heat-discharging surface area of the tubularly configured heating element is enlarged by one of fluting and by a diamond-pattern texture.

14. The apparatus of claim 12, wherein a cavity remaining between the tubularly configured heating element, the electrically contacted connector stud, and the helically configured heating element is filled with an insulating material, and wherein the insulating material is a ceramic material.

15. The apparatus of claim 12, wherein the heating element extends substantially over an entire length of the heating tube from the lower side of the housing to the tip of the heating tube, so that the heating element uniformly heats the largest possible surface area of the heating tube.

16. The apparatus of claim 12, wherein the heating element is embodied helically as one component, and extends from an end face of a connector stud continuously to the tip of the heating tube.

17. The apparatus of claim 12, wherein the specific electrical resistance of the material of the heating element is between 0.07 μΩm and 0.6 μΩm at 20° C.

18. The apparatus of claim 12, further comprising:
an overheating protection device.

19. The apparatus of claim 12, wherein the overheating protection device includes a sensing arrangement to sense a rise in an electrical resistance of the heating element with increasing temperature, and that shut off current flow to the heating element when a threshold value is reached.

20. The apparatus of claim 12, wherein the overheating protection device includes a sensing arrangement to sense and differentiate a current through the heating element, and that shuts off current flow to the heating element in the event the derivative over time deviates from a value of zero.

21. The apparatus of claim 12, wherein the apparatus for heating fuel is integrated into an injection system of the combustion engine operable with alcohol or with an alcohol/gasoline mixture.

22. A metal sheathed-element glow plug apparatus for heating fuel, which includes alcohol, for operating a combustion engine that is operated with one of alcohol and an alcohol/gasoline mixture, comprising:
a metal sheathed-element glow plug heating element; and
a housing and a thin-walled heating tube that surrounds the heating element;
wherein the heating material is made of a material that exhibits a rise in its electrical resistance with an increasing temperature.

23. The apparatus of claim 12, wherein a cavity remaining between the tubularly configured heating element, the electrically contacted connector stud, and the helically configured heating element is filled with an insulating material, and wherein the insulating material is a ceramic material, which is magnesium oxide.
